(19) United States
(12) Patent Application Publication
(10) Pub. No.: US 2026/0361153 A1
(43) Pub. Date: Nov. 12, 2026

(54) STATOR

(71) Applicant: AISIN CORPORATION, Kariya (JP)

(72) Inventors: Daisuke MARUI, Kariya-shi (JP); Tomohiko TAKEMI, Kariya-shi (JP); Kiyotaka KOGA, Kariya-shi (JP)

(73) Assignee: AISIN CORPORATION, Kariya (JP)

(21) Appl. No.: 19/650,029

(22) Filed: Apr. 16, 2026

(30) Foreign Application Priority Data
May 7, 2025 (JP) 2025-077106

(51) Int. Cl. H02K 1/16; H02K 3/28

(52) U.S. Cl. CPC H02K 1/16; H02K 3/28

(57) ABSTRACT

A stator for a rotary electric machine includes: an annular stator core having a plurality of slots; and a plurality of segment coils accommodated in the plurality of slots. Each of the segment coils includes an accommodation portion accommodated in a respective one of the slots, and a coil end extending from the accommodation portion to one side in an axial direction, and a leg extending from the accommodation portion to the other side in the axial direction, the number of the accommodation portions accommodated in the slots and arranged in a radial direction is an odd number, the leg extending from the accommodation portion accommodated on an innermost side in the radial direction in the slot includes one of a first leg and a second leg that each extend from a respective one of two of the slots separated by a predetermined pitch in a circumferential direction, the first leg and the second leg are disposed on a radial outer side of a radially innermost side surface of the stator core, the first leg extends from the accommodation portion to one side in the circumferential direction, the second leg extends from the accommodation portion to the other side in the circumferential direction and is joined to the first leg to be offset to a radial outer side of the first leg such that a radial inner side surface of the second leg is in contact with a radial outer side surface of the first leg, and a third leg that is the leg extending from the accommodation portion other than the accommodation portion accommodated on the innermost side in the radial direction in the slot is offset to a radial outer side of the second leg.

### CROSS REFERENCE TO RELATED APPLICATIONS

This application is based on and claims priority under 35 U.S.C. § 119 to Japanese Patent Application 2025-077106, filed on May 7, 2025, the entire content of which is incorporated herein by reference.

### TECHNICAL FIELD

This disclosure relates to a stator.

### BACKGROUND DISCUSSION

In the related art, various arrangement structures of a coil of a coil end extending from an end surface of a stator core on one side in an axial direction to the one side in the axial direction have been proposed. For example, JP 2022-74588A (Reference 1) discloses a configuration in which a coil end connects coil side portions (portions accommodated in slots) of an innermost layer in a radial direction, and a joint portion is bent to protrude toward a radial inner side of the innermost layer (Reference 1, claim 8).

A rotor is disposed in a radial inner side portion of an annular stator core. In general, a size of an outer circumferential surface of the rotor in the radial direction is slightly smaller than a size of an inner circumferential surface of the stator core in the radial direction. Therefore, when the coil end protrudes toward a radial inner side as in the related art, the coil end and the rotor interfere with each other when the rotor is moved in the axial direction and disposed on a radial inner side of the stator core. Accordingly, in order to avoid interference between the coil end and the rotor, it is necessary to dispose the rotor on the radial inner side of the stator core by moving the rotor in the axial direction from a side where the coil end bent to protrude toward the radial inner side is not present in the axial direction. As described above, when an insertion direction of the rotor is restricted, various restrictions occur in a manufacturing process of a rotary electric machine.

The present disclosure has been made in view of the above problems, and an object of the present disclosure is to provide a technique for reducing restrictions in a manufacturing process of a rotary electric machine.

### SUMMARY

According to an aspect of this disclosure, a stator for a rotary electric machine includes: an annular stator core having a plurality of slots; and a plurality of segment coils accommodated in the plurality of slots. Each of the segment coils includes an accommodation portion accommodated in a respective one of the slots, a coil end extending from the accommodation portion to one side in an axial direction, and a leg extending from the accommodation portion to the other side in the axial direction, the number of accommodation portions accommodated in the slots and arranged in a radial direction is an odd number, the leg extending from the accommodation portion accommodated on an innermost side in the radial direction in the slot includes one of a first leg and a second leg that each extend from a respective one of two of the slots separated by a predetermined pitch in a circumferential direction, the first leg and the second leg are disposed on a radial outer side of a radially innermost side surface of the stator core, the first leg extends from the accommodation portion to one side in the circumferential direction, the second leg extends from the accommodation portion to the other side in the circumferential direction and is joined to the first leg to be offset to a radial outer side of the first leg such that a radial inner side surface of the second leg is in contact with a radial outer side surface of the first leg, and a third leg that is the leg extending from the accommodation portion other than the accommodation portion accommodated on the innermost side in the radial direction in the slot is offset to a radial outer side of the second leg.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view illustrating a stator;

FIG. 2A is a view illustrating a state in which a part of the stator is viewed along an axial direction of a stator core, and FIG. 2B is an enlarged cross-sectional view illustrating a state in which coils are cut in a direction perpendicular to the axial direction at a position of an end surface of the stator core;

FIG. 3 is a view illustrating the stator as viewed from a radial direction;

FIG. 4 is a perspective view illustrating the coil and the stator core that are positioned on an innermost side in the radial direction;

FIG. 5 is a plan view illustrating the coil and the stator core that are positioned on the innermost side in the radial direction;

FIG. 6 illustrates a Y-connection;

FIG. 7 is a diagram illustrating an arrangement of three-phase coils in slots;

FIG. 8 is a diagram illustrating positions of the coils in the radial direction and a circumferential direction;

FIG. 9 is a diagram illustrating the positions of the coils in the radial direction and the circumferential direction;

FIG. 10 is a diagram illustrating the positions of the coils in the radial direction and the circumferential direction; and

FIG. 11 is a diagram illustrating the positions of the coils in the radial direction and the circumferential direction.

### DETAILED DESCRIPTION

Here, an embodiment disclosed here will be described in accordance with the following order.
(1) Configuration of Stator:
(2) Detailed Configuration of Leg:
(3) Example of Winding:
(4) Other Embodiments:

### (1) Configuration of Stator

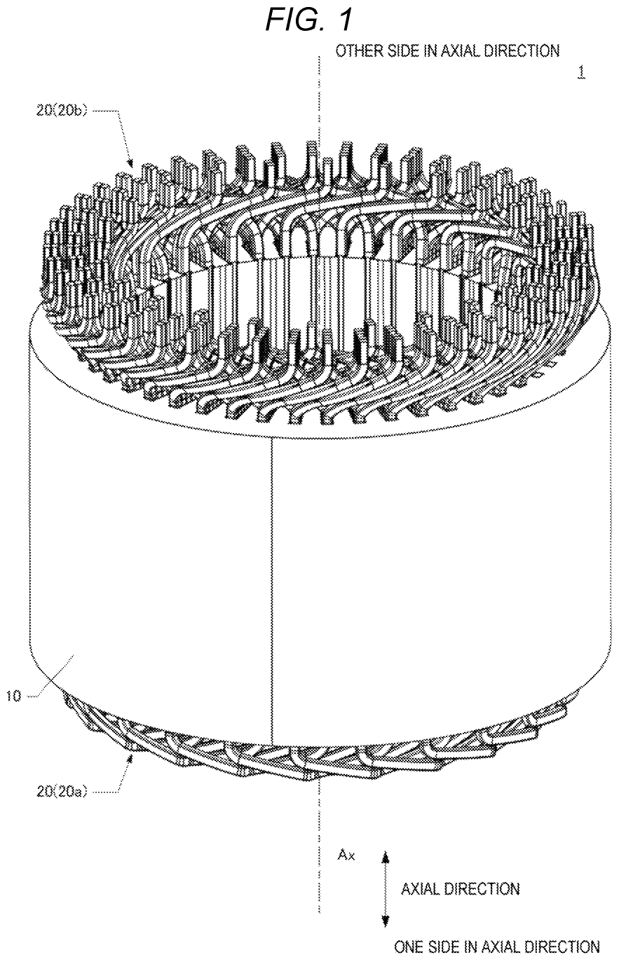

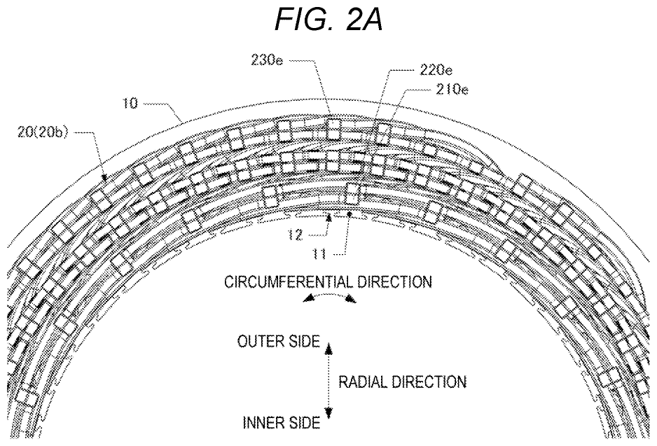

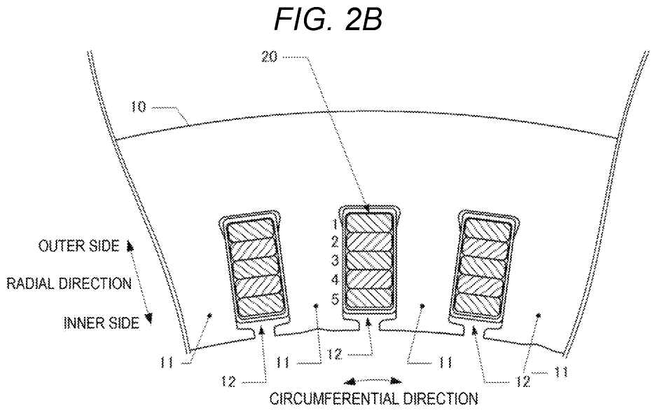

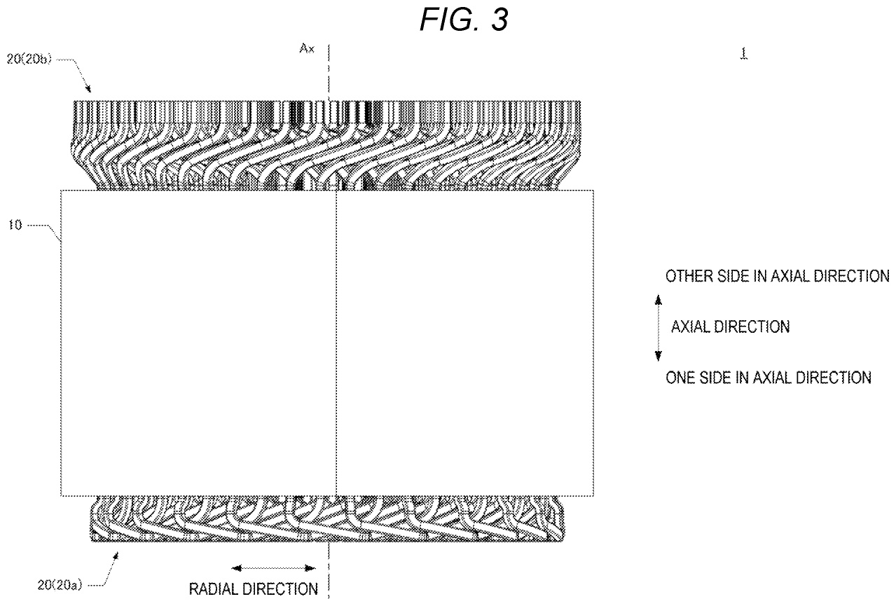

FIG. 1 is a perspective view of a stator 1 of a rotary electric machine according to the present embodiment. The stator 1 includes a stator core 10 and coils 20. FIG. 2A is a view illustrating a state in which a part of the stator 1 is viewed along an axial direction of the stator core 10. FIG. 2B is an enlarged cross-sectional view illustrating a state in which the coils 20 are cut in a direction perpendicular to the axial direction at a position of an end surface of the stator core 10. In FIG. 2B, a cut surface of the coil 20 is hatched. FIG. 3 is a view illustrating a state in which the stator 1 is viewed along a radial direction.

The stator core 10 according to the present embodiment is an annular member. A rotor (not illustrated) is disposed inside a ring formed by the stator core 10. The rotor is a member that rotates about a central axis of the ring formed by the stator core 10 as a rotation axis Ax. In the present specification, a direction parallel to a rotation axis Ax is referred to as the axial direction, a direction perpendicular to the rotation axis Ax is referred to as the radial direction, and a rotation direction about the rotation axis Ax is referred to as a circumferential direction. In the radial direction, a direction separated from the rotation axis Ax is referred to as a radial outer side, and a direction approaching the rotation axis Ax is referred to as a radial inner side.

The stator core 10 includes a plurality of teeth 11 arranged in the circumferential direction and a plurality of slots 12 formed between the teeth 11 in the circumferential direction (see FIG. 2B). In the present embodiment, the teeth 11 are portions that protrude toward the radial inner side from the radial outer side. The teeth 11 are formed at regular intervals in the circumferential direction on an entire inner circumference of the stator core 10. The number of teeth 11 may be any number. In the present embodiment, cross-sectional shapes of teeth 11 in the direction perpendicular to the axial direction are the same at any position in the axial direction. Therefore, the teeth 11 are portions that protrude from the radial outer side toward the radial inner side in the radial direction and extend in the axial direction in a state where the cross-sectional shapes in the direction perpendicular to the axial direction are the same.

A space formed between the teeth 11 in the circumferential direction is the slot 12. The coil 20 is accommodated in the slot 12. The number of coils 20 accommodated in the slots 12 and arranged in the radial direction is an odd number. The number of coils 20 arranged in the radial direction is not limited as long as the number is an odd number, and is five in the present embodiment. In FIG. 2B, the coils 20 arranged in the slot 12 are denoted by turn numbers 1 to 5. The turn number is a number for description, and is not described in the stator core 10. In the present embodiment, an outermost diameter side is denoted by the turn number 1, and an innermost diameter side is denoted by the turn number 5. In the present embodiment, the rotary electric machine is operated by a three-phase alternating current. Therefore, the coil 20 is a three-phase coil including three phases of a U-phase, a V-phase, and a W-phase.

In the present embodiment, the coil 20 is formed by welding a plurality of segment coils. Each of the segment coils includes two accommodation portions accommodated in a respective one of the two slots 12, a coil end 20a protruding from the end surface of the stator core 10 toward one side in the axial direction, and a leg 20b protruding from the end surface of the stator core 10 toward the other side in the axial direction.

The coil end 20a is a portion that extends from the accommodation portion to one side in the axial direction. The coil end 20a is a portion that connects the accommodation portions disposed in the different slots 12, and is in a state of being connected before the coil 20 is inserted into the slot 12. That is, at a stage where the segment coil is manufactured, the coil end 20a connecting the accommodation portions is formed in the segment coil.

The leg 20b is a portion that extends from the accommodation portion to the other side in the axial direction. The leg 20b is a portion connecting the accommodation portions disposed in the different slots 12. The legs 20b of the different segment coils disposed in the different slots 12 are connected by welding. That is, on the other side in the axial direction, after the segment coils are inserted into the slots 12, the legs 20b each extending from the accommodation portion are bent and brought into contact with each other, and are welded.

Since the legs 20b are bent such that distal ends of the segment coils are in contact with each other, the legs 20b are generally bent in the circumferential direction. In addition, since a large number of legs 20b are present in the space in which the legs 20b are disposed, the legs 20b are also bent in the radial direction so as not to interfere with each other. On the other hand, the rotor is disposed on a radial inner side of the stator core 10. In general, a size of an outer circumferential surface of the rotor in the radial direction is slightly smaller than a size of an inner circumferential surface of the stator core in the radial direction. Therefore, if the coil 20 protrudes toward the radial inner side as in the related art, the coil 20 and the rotor interfere with each other when the rotor is moved in the axial direction and disposed on the radial inner side of the stator core. Therefore, in the present embodiment, on both one side and the other side in the axial direction of the stator core 10, the coil 20 is disposed on a radial outer side of a radially innermost side surface of the stator core 10.

In the present embodiment, after the accommodation portion is accommodated in the slot 12, the coil end 20a is not bent, and a shape of the coil end 20a formed as a segment coil is maintained. Accordingly, at a stage of manufacturing the segment coil, a shape of the coil end 20a is determined such that the coil ends 20a are disposed without interfering with each other. In the present embodiment, the shape of the coil end 20a is determined such that the coil end 20a is disposed on the radial outer side of the radially innermost side surface of the stator core 10.

On the other hand, since the leg 20b is a portion extending linearly at the stage of being manufactured as a segment coil, the leg 20b is bent in the circumferential direction and the radial direction after the accommodation portion of the segment coil is accommodated in the slot 12. At this time, the bending process is performed such that the legs 20b are disposed on the radial outer side of the radially innermost side surface of the stator core 10. With the above configuration, in the present embodiment, the rotor can be disposed at a portion on the radial inner side of the stator core 10 from both the one side and the other side in the axial direction. Therefore, a moving direction of the rotor is not restricted, and restrictions in a manufacturing process of the rotary electric machine can be reduced.

### (2) Detailed Configuration of Leg

Hereinafter, specifically, a configuration of the leg 20b will be described in detail. In the present embodiment, the legs 20b of the radially innermost coil 20 (the coil having the turn number 5) are referred to as a first leg 210 and a second leg 220. Positions of the first leg 210 and the second leg 220 in the radial direction are positions obtained by extending the accommodation portion present on the innermost side in the radial direction in the axial direction or positions offset to the radial outer side of the positions. The leg 20b of the coil 20 (the coil having the turn numbers 1 to 4) present on the radial outer side of the turn number 5 is referred to as a third leg 230. The third leg 230 is offset to the radial outer side in accordance with the offset of the first leg 210 and the second leg 220 so as not to interfere with the first leg 210 and the second leg 220.

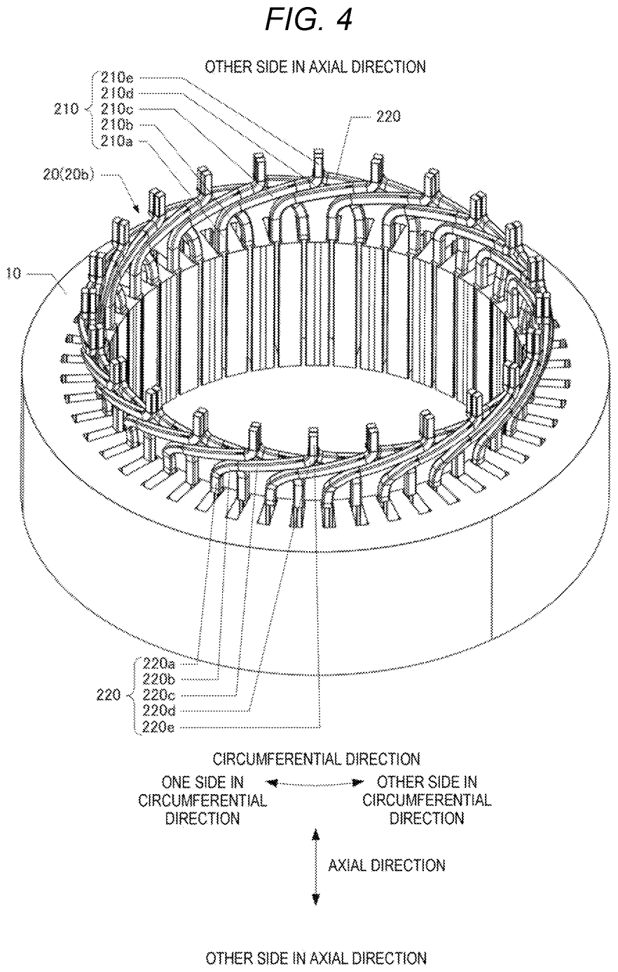

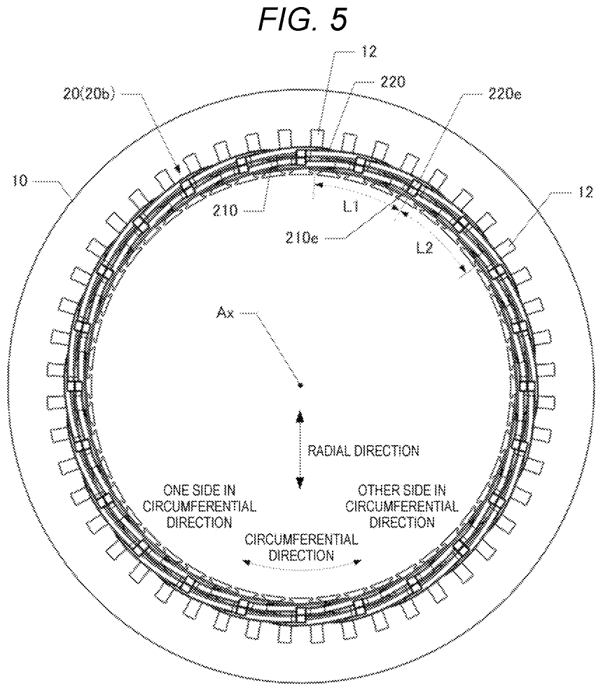

Here, the first leg 210 and the second leg 220 will be described in detail. FIG. 4 is a perspective view illustrating the first leg 210 and the second leg 220 extracted from the coil 20 together with the stator core 10. FIG. 5 is a plan view illustrating the first leg 210 and the second leg 220 extracted from the coil 20 together with the stator core 10. That is, FIG. 5 illustrates a state viewed from the other side in the axial direction along the axial direction.

The leg 20b extending from the accommodation portion accommodated on the innermost side in the radial direction in the slot 12, that is, the coil 20 having the turn number 5 is either the first leg 210 or the second leg 220. In the present embodiment, each of the first leg 210 and the second leg 220 extends from a respective one of the two slots 12 separated by a predetermined pitch in the circumferential direction. In the present embodiment, the predetermined pitch is larger than a circumferential pitch of two of the slots 12 accommodating the accommodation portion from which the third leg 230 extends.

The circumferential pitch is an interval in the circumferential direction of the slots 12 accommodating the accommodation portion connected by the leg 20b. In the present embodiment, since the slots 12 are formed at regular intervals in the circumferential direction in the stator core 10, the pitch is expressed by the number of slots 12 in the present specification. Hereinafter, a pitch of the slot 12 accommodating the accommodation portion connected to the first leg 210 and the slot 12 accommodating the accommodation portion connected to the second leg 220 is simply referred to as a pitch of the first leg 210 and the second leg 220. The pitch of the slots 12 accommodating the accommodation portion connected to the third leg 230 is simply referred to as a pitch of the third legs 230.

In the present embodiment, the pitch of the third legs 230 is a standard magnetic pole pitch. The standard magnetic pole pitch is the number of slots/the number of magnetic poles. In the present embodiment, a total of 48 slots 12 are formed in the stator core 10, and the number of magnetic poles formed in the stator is 8, so the standard magnetic pole pitch is 6. On the other hand, the pitch of the first leg 210 and the second leg 220 is 7, which is larger than 6.

As described above, the positions of the first leg 210 and the second leg 220 in the radial direction are the positions obtained by extending the accommodation portion present on the innermost side in the radial direction in the axial direction or the positions offset to the radial outer side of the positions. Specifically, the first leg 210 includes an extension portion 210a, a first bent portion 210b, an oblique portion 210c, a second bent portion 210d, and a joint portion 210e. The extension portion 210a is a portion that extends from the accommodation portion in the axial direction. The first bent portion 210b is a portion that extends from the extension portion 210a in the axial direction and is bent toward one side in the circumferential direction. The oblique portion 210c is a portion that extends from the first bent portion 210b in the axial direction and extends toward one side in the circumferential direction. The second bent portion 210d is a portion that extends from the oblique portion 210c to one side in the circumferential direction and is bent in the axial direction. The joint portion 210e is a portion that extends from the second bent portion 210d toward one side in the axial direction.

The second leg 220 includes an extension portion 220a, a first bent portion 220b, an oblique portion 220c, a second bent portion 220d, and a joint portion 220e. The extension portion 220a is a portion that extends from the accommodation portion in the axial direction. The first bent portion 220b is a portion that extends from the extension portion 220a in the axial direction and is bent toward the other side in the circumferential direction. The oblique portion 220c is a portion that extends from the first bent portion 220b in the axial direction and extends toward the other side in the circumferential direction. The second bent portion 220d is a portion that extends from the oblique portion 220c to the other side in the circumferential direction and is bent in the axial direction. The joint portion 220e is a portion that extends from the second bent portion 220d toward the other side in the axial direction.

In the present embodiment, the radial position of the first leg 210 coincides or substantially coincides with an annular region formed by rotating the coil 20 disposed on the innermost side in the radial direction in the slot 12 in the circumferential direction. In the present embodiment, in the first leg 210, the second bent portion 210d and the joint portion 210e are slightly offset to the radial outer side, but are not substantially bent in the radial direction.

On the other hand, the second leg 220 is offset to the radial outer side of the first leg 210 by a thickness of the coil 20. Specifically, the extension portion 220a of the second leg 220 extends from the accommodation portion in the axial direction and is offset to the radial outer side. The extension portion 210a of the first leg 210 extends from the accommodation portion in the axial direction, but is not offset in the radial direction. An amount by which the extension portion 220a is offset to the radial outer side is an amount corresponding to the thickness of the coil 20 in the radial direction. That is, the second leg 220 is offset to the radial outer side by the thickness of one coil 20 with respect to the first leg 210.

The first bent portion 220b is bent from the extension portion 220a toward the other side in the circumferential direction and extends toward the other side in the circumferential direction, but is not offset in the radial direction. The first bent portion 220b corresponds to a bent portion in the claims. According to the above configuration, the second leg 220 includes a plurality of portions, that is, the extension portion 220a, the first bent portion 220b, the oblique portion 220c, the second bent portion 220d, and the joint portion 220e, and is offset in the radial direction in the extension portion 220a, which is one of the plurality of portions. Therefore, it is not necessary to offset the second leg 220 in the radial direction at other portions, and it is not necessary to perform complicated bending in the radial direction when bending the leg 20b.

In the present embodiment, the joint portions 210e and 220e are joined to each other by welding. Specifically, the second leg 220 is offset to the radial outer side from the first leg 210, and a radial inner side surface of the joint portion 220e of the second leg 220 is in contact with a radial outer side surface of the joint portion 210e of the first leg 210. The joint portions 210e and 220e are welded in this state.

Further, in the present embodiment, a circumferential length L1 (see FIG. 5) from the joint portion 210e of the first leg 210 to the slot 12 accommodating the accommodation portion from which the first leg 210 extends is equal to a circumferential length L2 (see FIG. 5) from the joint portion 220e of the second leg 220 to the slot 12 accommodating the accommodation portion from which the second leg 220 extends. Therefore, the joint portions 210e and 220e are present at a center of the accommodation portion to which the first leg 210 is connected and the accommodation portion to which the second leg 220 is connected in an accommodation hole. Since the pitch of the first leg 210 and the second leg 220 is 7, the joint portions 210 e and 220 e are present at positions corresponding to 3.5 pitches from the accommodation portion in the circumferential direction.

On the other hand, in the third leg 230, similarly to the first leg 210 and the second leg 220, ends of the segment coils are joined at a center of the third leg 230 in the circumferential direction, but since the pitch of the third leg 230 is 6, a joint portion is present at a position of 3 (=6/2) pitches from the accommodation portion. Therefore, the joint portion (denoted as a joint portion 230e in FIG. 2) of the third leg 230 is present on a position of the slot 12 in the circumferential direction. On the other hand, the joint portions 210e and 220e are present at positions of the teeth 11 instead of the slots 12 in the circumferential direction. Therefore, a position of the joint portion 230e in the circumferential direction is different from positions of the joint portions 210e and 220e in the circumferential direction. Therefore, for example, when a coolant for cooling the coil 20 is applied from an upper side to a lower side in FIG. 2, the coolant is easily applied to both the joint portion 230e and the joint portions 210e and 220e. Therefore, the cooling efficiency can be increased as compared with a configuration in which all the joint portions are present at the same position in the circumferential direction.

As described above, in the present embodiment, the first leg 210 is present at the same position as the accommodation portion disposed on the innermost side in the radial direction or on the radial outer side. The second leg 220 is present at the same position as the first leg 210 in the radial direction or on the radial outer side. Therefore, the first leg 210 and the second leg 220 are disposed on the radial outer side of the radially innermost side surface of the stator core 10.

The third leg 230, which is a leg extending from the accommodation portion other than the accommodation portion accommodated on the innermost side in the radial direction in the slot 12, is offset to the radial outer side of the first leg 210 and the second leg 220. That is, the third leg 230 is offset to the radial outer side of the first leg 210 and the second leg 220 so as not to interfere with the first leg 210 and the second leg 220.

Therefore, when the rotor is moved from the other side in the axial direction to the one side in the axial direction, the first leg 210 and the second leg 220 do not interfere with the rotor. Accordingly, it is possible to move the rotor from the other side in the axial direction to the one side in the axial direction and dispose the rotor at the portion on the radial inner side of the stator core 10. In the present embodiment, the coil end 20a is also disposed on the radial outer side of the radially innermost side surface of the stator core 10. Therefore, when the rotor is moved from the one side in the axial direction to the other side in the axial direction, the coil end 20a and the rotor do not interfere with each other. With the above configuration, the moving direction of the rotor is not restricted, and restrictions in the manufacturing process of the rotary electric machine can be reduced.

### (3) Example of Winding

As described above, in the present embodiment, a pitch of the legs 20b extending from the accommodation portion accommodated on the innermost side in the radial direction is larger than a pitch of the legs 20b extending from the accommodation portion accommodated at another position in the radial direction. When the coil 20 is formed by the leg 20b having such a relation, the above-described embodiment can be realized by offsetting the second leg 220 to the radial outer side of the first leg 210.

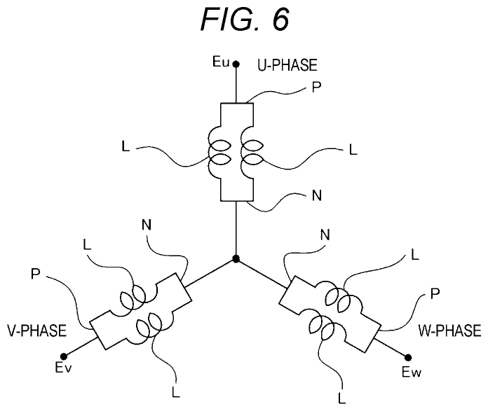

Here, an example of a winding using a coil having such a pitch will be described. In the present example, it is assumed that the three-phase coils 20 are connected by, for example, a Y connection (star connection) illustrated in FIG. 6. FIG. 6 illustrates a configuration in which two phases are arranged in parallel. For example, for the U-phase, two sets of rows (coil arrays L) of a plurality of coils 20 connected in series are connected in parallel. In each set of the coil arrays L, the legs 20b on the other side in the axial direction are welded to each other. A terminal (power line P illustrated in FIG. 6) extending from the coil 20 located at one end of the coil array L is electrically connected to a control circuit via a bus bar or the like. A terminal (neutral line N illustrated in FIG. 6) of the coil 20 located at the other end of the coil array L is electrically connected to a neutral line. Of course, the number of parallel coil arrays L is optional, and may be two or more. In addition, it is also possible to configure a circuit configuration in which the number of coil arrays L is one and is not parallel.

In the present embodiment, the coil 20 is formed by inserting a plurality of segment coils into the slots 12 of the stator core 10. When the segment coils are inserted into the slots 12 and the legs 20b are welded to each other on the other side in the axial direction, the coil 20 is wound around the stator core 10.

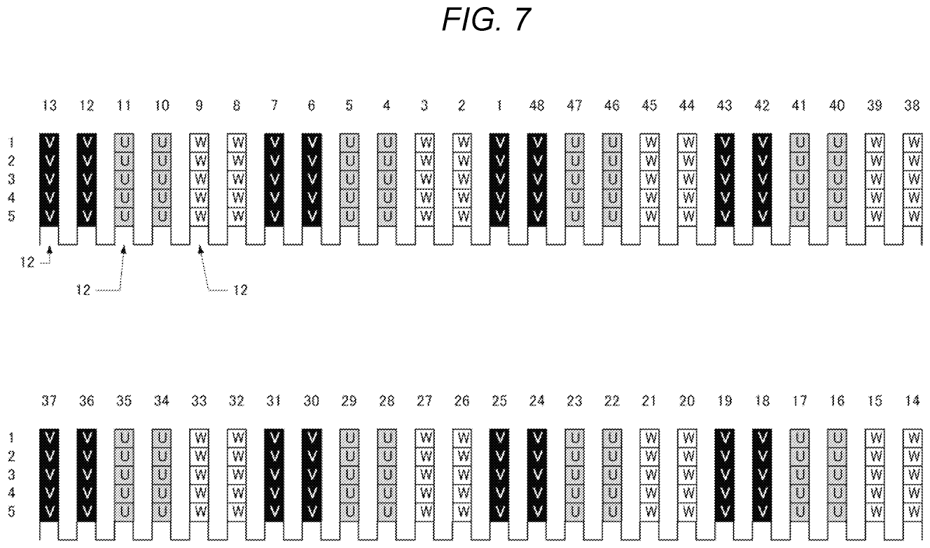

There are various methods for winding the coil 20 around the tooth 11 as described above. FIG. 7 is a diagram illustrating the arrangement of the three-phase coils 20 in the slots 12. In FIG. 7, the slots 12 arranged in the circumferential direction are arranged in the left-right direction, the turn numbers arranged in the radial direction are arranged in the up-down direction, and one rectangle indicates a position of one coil 20. The number added above the rectangle is a slot number given to the slot 12, and the number added to the left of the rectangle is the turn number. That is, in the example illustrated in FIG. 7, there are a total of 48 slots 12, and when the slot 12 at a certain position is the first slot 12, a number is assigned by increasing a value counterclockwise in the circumferential direction. In the example illustrated in FIG. 7, since the upper side of the drawing is the radial outer side, the accommodation portion of the coil 20 having the turn number 1 on the outermost diameter side is positioned at an uppermost portion of the eight arranged rectangles, and the accommodation portion of the coil 20 having the turn number 8 on the innermost diameter side is positioned at a lowermost portion of the eight arranged rectangles.

In FIG. 7, the U-phase coil, the V-phase coil, and the W-phase coil are indicated by gray, black, and white rectangles with letters U, V, and W, respectively. As illustrated in FIG. 7, in the present embodiment, all the coils 20 disposed in two adjacent slots 12 are the coils of the same phase. Further, with respect to the U-phase coils arranged in the two slots 12, the W-phase coil is adjacent to one side in the circumferential direction, and the V-phase coil is adjacent to the other side in the circumferential direction. In a respective one of the V-phase coil and the W-phase coil, coils of the same phase are arranged at positions of all turn numbers in the two adjacent slots 12.

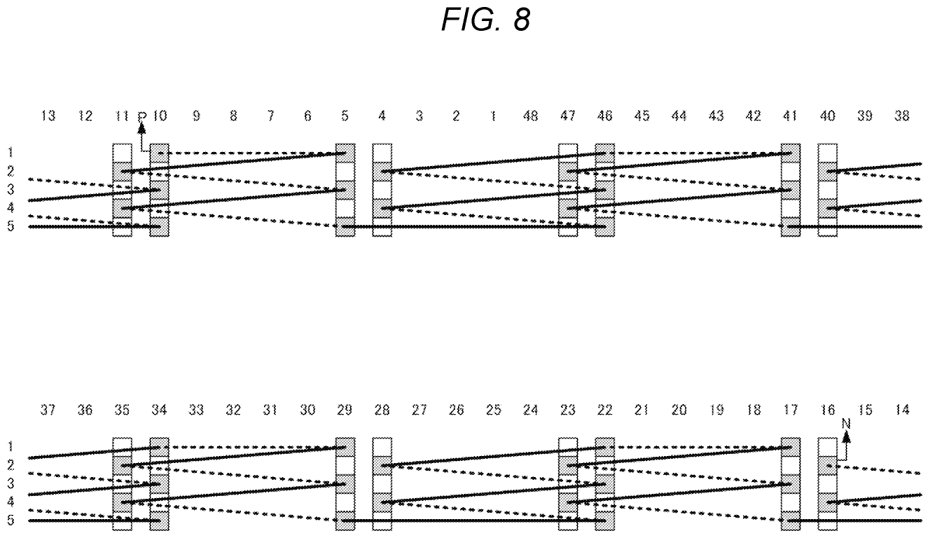

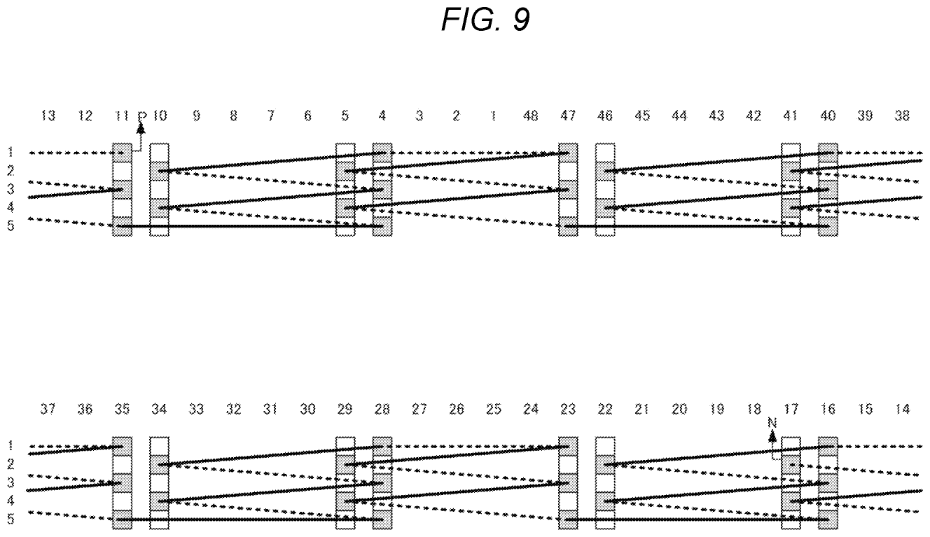

Next, a winding method for realizing the coil 20 of each phase by a segment coil will be described. A coil can be wound around each of the U-phase, the V-phase, and the W-phase according to the same idea, and thus the description will be made focusing on the U-phase which is one of the phases. FIGS. 8 and 9 are diagrams illustrating the positions of the slots 12 with the same slot numbers as in FIG. 7, and illustrating the positions of the coils in the radial direction and the circumferential direction in the slots 12 with the same rectangles as in FIG. 7. However, in FIGS. 8 and 9, only a slot number in which the U-phase coil is arranged is extracted and illustrated.

In FIGS. 8 and 9, the coil end 20a present on one side in the axial direction is indicated by a broken line, and the leg 20b present on the other side in the axial direction is indicated by a solid line. For example, in FIG. 8, a position of the turn number 1 in the slot number 5 and a position of the turn number 2 in the slot number 11 are connected by a solid line. This indicates that, on the other side in the axial direction, the leg 20b is present across the position of the turn number 1 in the slot number 5 and the position of the turn number 2 in the slot number 11.

In FIG. 8, a position of the turn number 3 in the slot number 5 and the position of the turn number 2 in the slot number 11 are connected by a broken line. This indicates that, on the one side in the axial direction, the coil end 20a is present across the position of the turn number 3 in the slot number 5 and the position of the turn number 2 in the slot number 11.

When the coil 20 is wound around the teeth 11, one longer coil is formed by joining the legs 20b of the plurality of segment coils on the other side in the axial direction. One end of the longer coil formed of the plurality of segment coils is electrically connected to the power line P illustrated in FIG. 6 described above, and the other end is electrically connected to the neutral line N illustrated in FIG. 6 described above. In FIGS. 8 and 9, a rectangle indicating an accommodation portion of the coil 20 connected to the power line P and a rectangle indicating an accommodation portion of the coil 20 connected to the neutral line N are indicated by arrows. In addition, a letter P or N is attached to a tip of the arrow extending from each rectangle, and indicates whether a connection destination is the power line P or the neutral line N.

The coil illustrated in FIGS. 8 and 9 adopts a winding method known as double winding. In the double winding, when viewed along the axial direction except for the innermost side and the outermost side in the radial direction, a direction of the coil end 20a is oriented in a substantially constant oblique direction, and a direction of the leg 20b is oriented in a substantially constant oblique direction. The direction of the coil end 20a is opposite to the direction of the leg 20b. At an innermost position and an outermost position in the radial direction, the segment coils extend over positions of the same turn number.

For example, in the example illustrated in FIG. 8, the broken line connecting the position of the slot number 5 and the turn number 3 and the position of the slot number 11 and the turn number 2 and a broken line connecting a position of the slot number 5 and the turn number 5 and a position of the slot number 11 and the turn number 4 are parallel and oriented in the same direction. The solid line connecting the position of the slot number 5 and the turn number 1 and the position of the slot number 11 and the turn number 2 and a solid line connecting the position of the slot number 5 and the turn number 3 and the position of the slot number 11 and the turn number 4 are parallel and oriented in the same direction. The solid line and the broken line are opposite to each other (symmetrical). As described above, in the double winding, the coil 20 is disposed with respect to the stator core 10 such that the leg 20b and the coil end 20a are substantially oriented in the same direction opposite to each other between the adjacent magnetic poles and are repeated along the radial direction.

Here, an example is assumed in which two coil arrays L are connected in parallel. Therefore, two U-phase coils exist in parallel. Therefore, another U-phase coil is formed in parallel with one coil illustrated in FIG. 8. FIG. 9 illustrates a winding example of another single U-phase coil. For example, it is a double winding in which the leg 20b extending between a position of the slot number 4 and the turn number 1 and a position of the slot number 10 and the turn number 2, and the coil end 20 a extending between a position of the slot number 4 and the turn number 3 and the position of the slot number 10 and the turn number 2 are present. By winding the coil as illustrated in FIGS. 8 and 9, the coil is wound so that two U-phase coils are arranged in parallel. The V-phase coil and the W-phase coil may be wound in the same manner.

In the coil 20 wound as described above, attention is paid to the leg 20b extending to the other side in the axial direction from an accommodation portion having the turn number 5. For example, in the example illustrated in FIG. 8, there is a solid line extending from the position of the slot number 5 and the turn number 5 to a position of a slot number 46 and the turn number 5. In addition, a pitch of the slot number 46 to the slot number 5 is a pitch of seven slots, and thus is a predetermined pitch. As illustrated in FIGS. 8 and 9, a pitch of all the legs 20 b connecting the accommodation portions having the turn number 5 is 7. In the examples illustrated in FIGS. 8 and 9, all the coils extending over the position of the turn number 5 are solid lines. Therefore, a coil connecting the accommodation portions having the turn number 5 can be configured by the leg 20 b disposed on the other side in the axial direction, that is, the first leg 210 and the second leg 220.

The pitch of the first leg 210 and the second leg 220 which are the legs 20b connecting the accommodation portions having the turn number 5 is 7, and the pitch of the third legs 230 connecting the accommodation portions of different turn numbers is 6, and the former is larger than the latter. In the case of the double winding, the third legs 230 can be formed at the same pitch, but no coil is disposed on the radial inner side of the turn number present on the radially innermost side. Therefore, by setting the pitch of the first leg 210 and the second leg 220 to be larger than the pitch of the third legs 230 at the turn number present on the innermost side in the radial direction, the coil 20 can be disposed to reach the adjacent magnetic pole.

### (4) Other Embodiments

The above embodiment is an example of carrying out this disclosure, and various other embodiments can be adopted. For example, a winding method, a winding order, and a winding direction are not limited. More specifically, the winding method is not limited to the double winding, and may be slope winding. Further, the winding method may be full-pitch winding or short-pitch winding. The arrangement order of the phases in the circumferential direction is not limited. Further, the number of poles, the number of slots, and the number of coils 20 arranged in the radial direction in the stator core 10 may be different from those in the above-described embodiment.

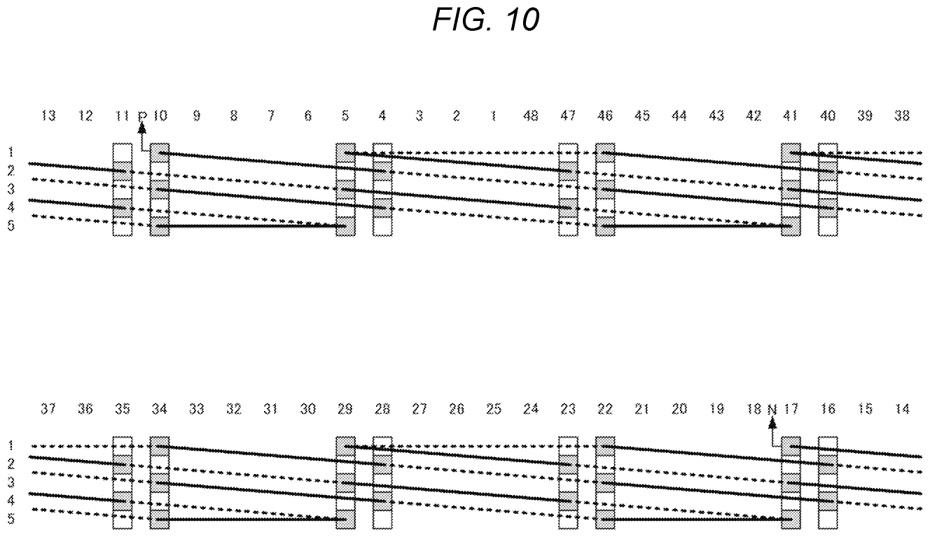

FIG. 10 is a diagram illustrating positions of the coils in the radial direction and the circumferential direction when the slope winding is adopted. In the slope winding, the coil end 20a and the leg 20b are oriented in a substantially constant oblique direction when viewed along the axial direction. Since a coil end cannot be arranged obliquely beyond a position of the outermost diameter and a position of the innermost diameter in the radial direction, the segment coils extend over the positions of the same turn number at the position of the outermost diameter and the position of the innermost diameter. The notations of slot numbers and turn numbers in FIG. 10 are the same as those in FIGS. 8 and 9. Also in FIG. 10, only slot numbers in which the U-phase coils are arranged are extracted and illustrated.

For example, in the example illustrated in FIG. 10, the broken line connecting the position of the slot number 5 and the turn number 3 and the position of the slot number 11 and the turn number 2 and a solid line connecting a position of the slot number 4 and the turn number 2 and a position of the slot number 10 and the turn number 1 are parallel and oriented in the same direction. As described above, in the slope winding, the leg 20b and the coil end 20a are oriented in the same direction, and the leg 20b and the coil end 20a are also oriented in the same direction in the adjacent magnetic poles. Therefore, when the solid line and the broken line indicating the leg 20b and the coil end 20a are viewed along the axial direction, slopes having the same inclination appear to be continuous.

One U-phase coil is formed by winding the coil as illustrated in FIG. 10 described above. When the coils are wound so that two U-phase coils are arranged in parallel, another U-phase coil can be formed in parallel in FIG. 10 by connecting the positions of the U-phase coils indicated by white rectangles in FIG. 10. The V-phase coil and the W-phase coil are wound in the same manner to form the coil 20 by the slope winding.

In the coil 20 wound as described above, attention is paid to the leg 20b extending to the other side in the axial direction from the accommodation portion having the turn number 5. For example, in the example illustrated in FIG. 10, there is a solid line extending from the position of the slot number 5 and the turn number 5 to a position of the slot number 10 and the turn number 5. The leg 20 b indicated by the solid line includes the first leg 210 and the second leg 220.

In addition, a pitch of the slot number 10 to the slot number 5 is a pitch of five slots, and thus is a predetermined pitch. As illustrated in FIG. 10, all the pitch of the legs 20b connecting the accommodation portions having the turn number 5 is 5. On the other hand, a pitch of the third legs 230 connecting the accommodation portions having different turn numbers is 6, and the former is smaller than the latter. In the case of the slope winding, the third legs 230 can be formed at the same pitch, but no coil is disposed on the radial inner side of the turn number present on the radially innermost side. Therefore, by setting the pitch of the first leg 210 and the second leg 220 to be smaller than the pitch of the third legs 230 at the turn number present on the innermost side in the radial direction, the coil 20 can be disposed to reach the adjacent slope.

In such slope winding, the leg 20b present on the radially innermost side is also formed by the first leg 210 and the second leg 220, and the first leg 210 and the second leg 220 are disposed on the radial outer side of the radially innermost side surface of the stator core 10. According to this configuration, the moving direction of the rotor when the rotor is disposed inside the stator core 10 in the radial direction is not restricted, and the restrictions in the manufacturing process of the rotary electric machine can be reduced.

As described above, the coil 20 formed by disposing the first leg 210 and the second leg 220 on the radial outer side of the radially innermost side surface of the stator core 10 is applicable to various winding methods. In addition, the number of slots can be changed by increasing or decreasing a repetitive pattern in the circumferential direction. Further, the number of coils (the number of turns) arranged in the radial direction may be an odd number. That is, the third leg 230 and the coil end 20a in each of the double winding and the slope winding extend over two adjacent turn numbers. The third leg 230 and the coil end 20a do not intersect each other. Therefore, when attention is focused only on the coil extending over the third leg 230 and the coil end 20a, the total number is an even number. In the double winding and the slope winding, a constant pattern is repeated in the radial direction.

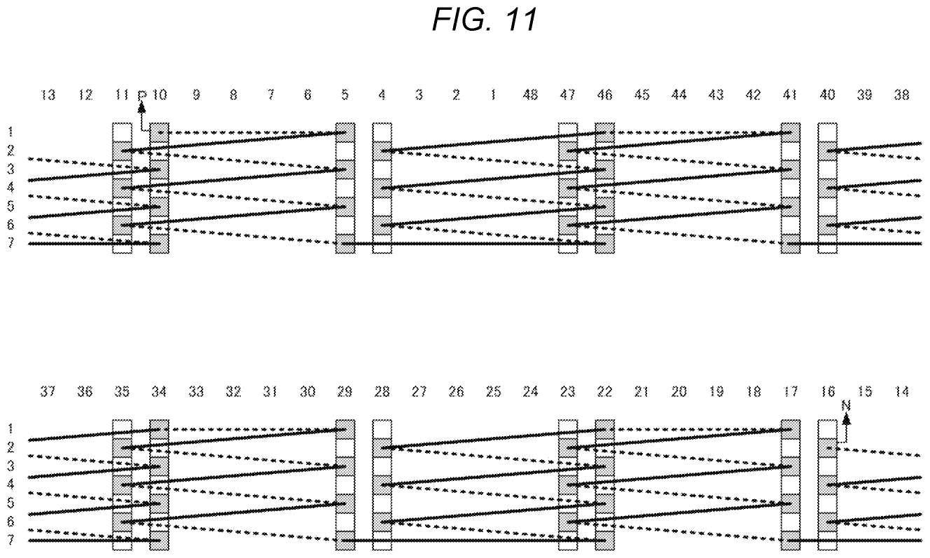

For example, in the case of the double winding illustrated in FIG. 8, a pattern constituted by a solid line and a broken line opposite to each other is repeated in the radial direction. In the case of the slope winding illustrated in FIG. 9, a slope constituted by a solid line and a broken line in the same direction is repeated in the radial direction. Such repetition of the pattern can be realized by an even number of turns. However, since a certain pattern cannot be repeated beyond a turn number at the innermost position in the radial direction, the leg 20b extending over the same turn number is constituted by the first leg 210 and the second leg 220 at the innermost position in the radial direction. Therefore, if the number of turns is an even number plus one, it is possible to provide the leg 20b extending over the innermost position in the radial direction. Therefore, the number of turns is not limited to five as long as the number is an odd number. FIG. 11 illustrates a winding example in which the number of turns is increased by two from the example illustrated in FIG. 8. The U-phase parallel to the winding illustrated in FIG. 11 can be realized by increasing the number of turns by two compared to the example illustrated in FIG. 8.

The stator core is an annular member having a plurality of slots. Teeth are disposed between the slots. The slot may be a space in which the coil is accommodated, and the number, size, and the like thereof are not limited. Although the stator core has an annular shape, a shape of the ring, for example, a shape of an outer periphery or an inner periphery is not limited.

The segment coil is a member accommodated in the plurality of slots, and is configured by electrically connecting coils of the same phase. That is, the rotary electric machine operates using three-phase wires having different phases. In general, the phases are shifted by the same interval (120°). The segment coil is formed by dividing a coil wound around the stator core into a plurality of portions, that is, segments.

The rotary electric machine may be any device capable of converting torque and electric power to each other, and may be a device that rotates by being supplied with electric power or a device that generates electric power by being rotated. The stator may be fixed to a support portion such as a motor case and generate a magnetic field by energization. That is, the stator is fixed so as not to rotate or move relative to the support portion. The stator may be any device that interacts with a magnetic field generated by the rotor to generate a magnetic field for applying torque to the rotor. The rotor is rotatably disposed on the radial inner side of the stator core.

The segment coil includes an accommodation portion accommodated in the slot, a coil end extending from the accommodation portion to one side in the axial direction, and a leg extending from the accommodation portion to the other side in the axial direction. The coil end is a portion connecting accommodation portions accommodated in the different slots, and is configured as a portion connecting the accommodation portions in a state where the segment coil is formed.

The leg is a portion extending from the accommodation portion to the other side in the axial direction, and the legs are not connected to each other in the state where the segment coil is formed. After the accommodation portion is accommodated in the slot, the legs are bent and joined to each other. That is, after the accommodation portion is accommodated in the slot, a first leg and a second leg are bent and joined to each other. The joining is performed between legs of the different segment coils. That is, the first leg of the first segment coil and the second leg of the second segment coil are joined.

The number of accommodation portions accommodated in the slots is not limited as long as the number of accommodation portions arranged in the radial direction is an odd number. That is, when the double winding or the slope winding is adopted in a configuration in which the number of accommodation portions arranged in the radial direction is an odd number, a portion connecting the accommodation portions on the innermost side in the radial direction is generated in the coil. Therefore, the portion connecting the accommodation portions on the innermost side in the radial direction can be configured by the first leg and the second leg.

The leg extending from the accommodation portion accommodated on the innermost side in the radial direction in the slot is one of the first leg and the second leg that each extend from a respective one of two slots separated by a predetermined pitch in the circumferential direction. That is, half of the leg extending from the accommodation portion accommodated on the innermost side in the radial direction is the first leg, and the remaining half is the second leg.

The first leg and the second leg may be disposed on the radial outer side of the radially innermost side surface of the stator core. That is, the rotor that moves in the axial direction and is disposed at a portion on the radial inner side of the stator core may move without interfering with the first leg and the second leg and move to a portion on the radial inner side of the stator core without interfering with other portions. Therefore, the present disclosure is not limited to a configuration in which the first leg and the second leg are disposed at the same position as the accommodation portion on the innermost side in the radial direction or on the radial outer side in the radial direction. Even if the first leg and the second leg are present inside the accommodation portion on the radially innermost side in the radial direction, the first leg and the second leg may be disposed on the radial outer side of the innermost side surface of the stator core in the radial direction.

The first leg may extend from the accommodation portion to one side in the circumferential direction, and the second leg may extend from the accommodation portion to the other side in the circumferential direction. That is, the first leg and the second leg extend in opposite directions to each other in the circumferential direction. Since the first leg and the second leg extend in opposite directions to each other in the circumferential direction, a radial inner side surface of the second leg may be in contact with a radial outer side surface of the first leg, and the first leg and the second leg may be joined to each other at this portion. The joining may be performed such that the first leg and the second leg are electrically connected, and examples thereof include joining by welding and joining by fusion.

The second leg is offset to the radial outer side of the first leg. The offset is realized by bending the leg to the radial inner side or the radial outer side with respect to a radial position of the accommodation portion to which the leg is connected. The second leg may be offset such that the radial inner side surface of the second leg is in contact with the radial outer side surface of the first leg, and an offset amount may be determined according to a shape of the first leg. The first leg may or may not be offset with respect to the radial position of the accommodation portion to which the first leg is connected.

The third leg, which is a leg extending from an accommodation portion other than the accommodation portion accommodated on the innermost side in the radial direction in the slot, may be offset to the radial outer side of the second leg. That is, the third leg may be offset to the radial outer side so as not to interfere with the first leg and the second leg.

According to an aspect of this disclosure, a stator for a rotary electric machine includes: an annular stator core having a plurality of slots; and a plurality of segment coils accommodated in the plurality of slots. Each of the segment coils includes an accommodation portion accommodated in a respective one of the slots, a coil end extending from the accommodation portion to one side in an axial direction, and a leg extending from the accommodation portion to the other side in the axial direction, the number of accommodation portions accommodated in the slots and arranged in a radial direction is an odd number, the leg extending from the accommodation portion accommodated on an innermost side in the radial direction in the slot includes one of a first leg and a second leg that each extend from a respective one of two of the slots separated by a predetermined pitch in a circumferential direction, the first leg and the second leg are disposed on a radial outer side of a radially innermost side surface of the stator core, the first leg extends from the accommodation portion to one side in the circumferential direction, the second leg extends from the accommodation portion to the other side in the circumferential direction and is joined to the first leg to be offset to a radial outer side of the first leg such that a radial inner side surface of the second leg is in contact with a radial outer side surface of the first leg, and a third leg that is the leg extending from the accommodation portion other than the accommodation portion accommodated on the innermost side in the radial direction in the slot is offset to a radial outer side of the second leg.

That is, in the stator, the number of accommodation portions accommodated in the slots and arranged in the radial direction is an odd number, and the first leg and the second leg connect the accommodation portions accommodated on the innermost side in the radial direction to each other as the number is an odd number. In this configuration, the first leg and the second leg are disposed on the radial outer side of the radially innermost side surface of the stator core. Therefore, the first leg and the second leg do not protrude toward the radial inner side of the stator core. Therefore, the first leg and the second leg do not interfere with the rotor when the rotor is disposed on the radial inner side of the stator core. Therefore, the rotor can be inserted on the radial inner side of the stator core from a side where the first leg and the second leg are disposed in the axial direction. As compared with a configuration in which the first leg and the second leg protruding toward the radial inner side, restrictions in a manufacturing process of a rotary electric machine can be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A stator for a rotary electric machine, the stator comprising:
an annular stator core having a plurality of slots; and
a plurality of segment coils accommodated in the plurality of slots, wherein each of the segment coils includes an accommodation portion accommodated in a respective one of the slots, and a coil end extending from the accommodation portion to one side in an axial direction, and a leg extending from the accommodation portion to the other side in the axial direction,
the number of the accommodation portions accommodated in the slots and arranged in a radial direction is an odd number,
the leg extending from the accommodation portion accommodated on an innermost side in the radial direction in the slot includes one of a first leg and a second leg that each extend from a respective one of two of the slots separated by a predetermined pitch in a circumferential direction,
the first leg and the second leg are disposed on a radial outer side of a radially innermost side surface of the stator core,
the first leg extends from the accommodation portion to one side in the circumferential direction,
the second leg extends from the accommodation portion to the other side in the circumferential direction and is joined to the first leg to be offset to a radial outer side of the first leg such that a radial inner side surface of the second leg is in contact with a radial outer side surface of the first leg, and
a third leg that is the leg extending from the accommodation portion other than the accommodation portion accommodated on the innermost side in the radial direction in the slot is offset to a radial outer side of the second leg.

2. The stator according to claim 1, wherein
the predetermined pitch is larger than a circumferential pitch of two of the slots accommodating the accommodation portion from which the third leg extends.

3. The stator according to claim 1, wherein
a circumferential length from a joint portion between the first leg and the second leg to the slot accommodating the accommodation portion from which the first leg extends is equal to a circumferential length from the joint portion to the slot accommodating the accommodation portion from which the second leg extends.

4. The stator according to claim 1, wherein
the second leg includes an extension portion extending from the accommodation portion in the axial direction and offset to the radial outer side, and a bent portion bent from the extension portion toward the other side in the circumferential direction and extending toward the other side in the circumferential direction.
